(19) United States
(12) Patent Application Publication
(10) Pub. No.: US 2026/0201801 A1
(43) Pub. Date: Jul. 16, 2026

(54) ADVANCED DETECTION APPARATUS AND METHOD FOR TUNNEL BORING MACHINE BASED ON SEISMIC WAVES FROM CONTROLLABLE SEISMIC SOURCE

(71) Applicant: SHANDONG UNIVERSITY, Jinan (CN)

(72) Inventors: Bin LIU, Jinan (CN); Lei CHEN, Jinan (CN); Yuxiao REN, Jinan (CN); Xinji XU, Jinan (CN); Hongyi CAO, Jinan (CN)

(21) Appl. No.: 19/562,944

(22) Filed: Mar. 11, 2026

Related U.S. Application Data
(63) Continuation of application No. PCT/CN2023/127955, filed on Oct. 30, 2023.

(30) Foreign Application Priority Data
Sep. 11, 2023 (CN) 202311167395X

(51) Int. Cl. E21D 9/00; E21D 9/10

(52) U.S. Cl. CPC E21D 9/003; E21D 9/10

(57) ABSTRACT

An advanced detection apparatus for a tunnel boring machine based on seismic waves from a controllable seismic source, the advanced detection apparatus may include: electromagnetic controllable seismic source assemblies arranged on both sides of a working platform of the tunnel boring machine and including a telescopic push rod, a counterweight housing, an airbag, a support, a first base, and a second base, wherein the telescopic push rod is fixed on a side of the counterweight housing facing the rock wall; and both the counterweight housing and the airbag are fixed to the first base, the airbag is located on a side of the counterweight housing distal from the telescopic push rod, and the first base is fixedly connected to the second base via the support.

### CROSS-REFERENCE TO RELATED APPLICATIONS

This patent application claims the priority benefits of Chinese Patent Application No. 202311167395.X, entitled “ADVANCED DETECTION APPARATUS AND METHOD FOR TUNNEL BORING MACHINE BASED ON SEISMIC WAVES FROM CONTROLLABLE SEISMIC SOURCE” filed with the China National Intellectual Property Administration on Sep. 11, 2023, the invention of which is incorporated by reference herein in its entirety as a part of the present application for all purposes.

### TECHNICAL FIELD

This disclosure relates to the technical field of advanced tunnel detection and, in particular, to an advanced detection apparatus and method for a tunnel boring machine based on seismic waves from a controllable seismic source.

### BACKGROUND

The statements in this section merely provide the background related to this disclosure and do not necessarily constitute prior art.

When tunnel boring machine-driven tunnels encounter adverse geology, they are prone to risks such as water inrush and mud outburst, which seriously threaten construction safety. As a commonly used advanced prediction method, seismic wave-based detection methods hold an important position in the detection of tunnel boring machine-driven tunnels. However, as tunnel construction extends into areas with complex terrain, the construction faces more severe and complex geological conditions, and the difficulty of seismic wave-based exploration will further increase.

The inventors have found that under extremely complex geological conditions, conventional seismic wave-based advanced detection methods have certain limitations when applied in tunnel boring machine-driven tunnels, including:
(1) conventional seismic excitation methods through manual hammering have weak excitation energy, and the signal propagation distance is limited by human power; while on-board hydraulic seismic sources and pneumatic seismic sources have improved excitation energy, they still struggle to meet the need for long-distance early detection of adverse geology under extremely complex geological conditions. Moreover, in the noisy tunnel boring machine-driven tunnel environment, long-distance effective reflections are easily drowned out, making them difficult to distinguish in seismic records;
(2) conventional active source detection methods excite signals through a single high-energy event, and excitation under conditions of broken surrounding rock may pose certain safety hazards; and
(3) advanced tunnel prediction often uses a fixed-position seismic source for excitation. This causes each excitation signal to propagate in all directions in the form of spherical waves, with relatively little effective energy propagating toward the tunnel face ahead. Consequently, the detection and imaging effects are not ideal.

### SUMMARY

To address the deficiencies of the prior art, this disclosure provides an advanced detection apparatus and method for a tunnel boring machine based on seismic waves from a controllable seismic source. The apparatus and method fully utilize space on both sides of a main control room of the tunnel boring machine to arrange electromagnetic controllable seismic source assemblies, achieving high-precision beamforming and reverse time migration imaging. By means of beam focusing, the signal-to-noise ratio of seismic records is improved and imaging accuracy is increased, compensating for the deficiency of strong but unfocused energy during detection using a controllable seismic source.

To achieve the above objectives, the following technical solutions are adopted by this disclosure:
in a first aspect, this disclosure provides an advanced detection apparatus for a tunnel boring machine based on seismic waves from a controllable seismic source.

The advanced detection apparatus for a tunnel boring machine based on seismic waves from a controllable seismic source includes: electromagnetic controllable seismic source assemblies arranged on both sides of a working platform of the tunnel boring machine;
the electromagnetic controllable seismic source assemblies each include a telescopic push rod, a counterweight housing, an airbag, a support, a first base, and a second base, where the telescopic push rod is fixed on a side of the counterweight housing facing a rock wall; and
both the counterweight housing and the airbag are fixed to the first base, the airbag is located on a side of the counterweight housing distal from the telescopic push rod, the first base is fixedly connected to the second base via the support, and the second base is configured to connect to the working platform of the tunnel boring machine.

As an optional implementation of the first aspect of this disclosure, the apparatus further includes an inflation device fixed on the second base, where the inflation device is in communication with the airbag.

As an optional implementation of the first aspect of this disclosure, the apparatus further includes three-component geophones arranged on the rock wall between a cutterhead and the electromagnetic controllable seismic source assemblies.

As a further limitation of the first aspect of this disclosure, the three-component geophones on both sides of a tunnel boring machine body are arranged symmetrically with respect to a central axis of the tunnel boring machine.

As an optional implementation of the first aspect of this disclosure, at least one electromagnetic controllable seismic source assembly is arranged on each side of the working platform of the tunnel boring machine, and the electromagnetic controllable seismic source assemblies on both sides are arranged symmetrically with respect to a central axis of the counterweight housing.

As an optional implementation of the first aspect of this disclosure, a main control room is fixed on the working platform of the tunnel boring machine, and the electromagnetic controllable seismic source assemblies are located on both sides of the main control room.

In a second aspect, this disclosure provides an operating method for an advanced detection apparatus for a tunnel boring machine based on seismic waves from a controllable seismic source as described above.

The operating method for an advanced detection apparatus for a tunnel boring machine based on seismic waves from a controllable seismic source utilizes the advanced detection apparatus for a tunnel boring machine based on seismic waves from a controllable seismic source according to the first aspect of this disclosure and includes the following steps:
when detection starts, activating the electromagnetic controllable seismic source assemblies on both sides of the working platform of the tunnel boring machine, extending the telescopic push rods of the electromagnetic controllable seismic source assemblies and making them contact the rock wall, and simultaneously, inflating the airbags of the electromagnetic controllable seismic source assemblies through the inflation device, so that the electromagnetic controllable seismic source assemblies can be pressed firmly against the rock wall; and
setting time-frequency information and output force information of the electromagnetic controllable seismic source assemblies, and after the electromagnetic controllable seismic source assemblies are activated, controlling, by moving coils inside the electromagnetic controllable seismic source assemblies, the counterweight housing to vibrate, thereby exciting seismic signals.

In a third aspect, this disclosure provides an advanced detection method for a tunnel boring machine based on seismic waves from a controllable seismic source, utilizing the advanced detection apparatus for a tunnel boring machine based on seismic waves from a controllable seismic source according to the first aspect of this disclosure and including the following steps:
synthesizing, by means of delayed excitation of each electromagnetic controllable seismic source assembly, a wavefront excited by each seismic source assembly in the form of spherical waves into a beam surface, and adjusting a propagation angle of the wavefront through different delay lengths;
receiving seismic records by three-component geophones, performing interferometric processing on seismic data from the controllable seismic source assemblies by means of cross-correlation, obtaining a wave velocity of direct waves through analysis, and creating a homogeneous initial velocity model based on a wave velocity result;
removing the direct waves in interferometric seismic records;
exciting seismic records at a seismic source assembly position of the obtained initial velocity model to obtain a forward-propagating wavefield; applying the actually obtained interferometric seismic records with the direct waves removed in reverse time at positions of the three-component geophones to obtain a reverse-propagating wavefield; and
performing correlation stacking on the two wavefields to obtain a reverse time migration imaging result based on beamforming.

As an optional implementation of the third aspect of this disclosure, when a forward propagation angle is θ, an excitation delay between each electromagnetic controllable seismic source assembly is calculated as follows:

$$t = \frac{x sin θ}{v} ,$$

where t represents a delayed excitation time of a current electromagnetic controllable seismic source assembly relative to a previous electromagnetic controllable seismic source assembly; x represents a spacing between the electromagnetic controllable seismic source assemblies; v represents a wave velocity in surrounding rock; θ represents the propagation angle of the wavefront; a delayed excitation time of a first electromagnetic controllable seismic source assembly t₀=0s; and a delayed excitation time of an nth electromagnetic controllable seismic source assembly

$${t}_{n} = {\sum }_{i = 0}^{n} {t}_{i} .$$

In a fourth aspect, this disclosure provides a tunnel boring machine including the advanced detection apparatus for a tunnel boring machine based on seismic waves from a controllable seismic source according to the first aspect of this disclosure.

Compared with the prior art, this disclosure has the following beneficial effects:

1. This disclosure innovatively proposes an advanced detection apparatus for a tunnel boring machine based on seismic waves from a controllable seismic source. The electromagnetic controllable seismic source assemblies excite seismic signals by pressing firmly against the rock wall and generating vibrations. Utilizing the characteristics of continuous excitation energy accumulation and controllability of seismic signals, the apparatus achieves the effect of improving the recognition capability of weak long-distance reflected signals while ensuring that the detection process does not cause damage to the rock wall.

2. This disclosure innovatively proposes a mounting method for an electromagnetic controllable seismic source detection apparatus, fully utilizing large space on both sides of the main control room of the tunnel boring machine. A plurality of electromagnetic controllable seismic source assemblies are arranged along a tunnel axis direction at positions close to the rock wall on both sides of the tunnel boring machine, further enriching the arrangement forms of seismic sources in tunnel boring machine-driven tunnels.

3. This disclosure innovatively proposes a tunnel beamforming and reverse time migration imaging method for a tunnel boring machine. By utilizing the plurality of controllable seismic source assemblies arranged on both sides of the main control room and the high precision of signal control by the controllable seismic source assemblies, it is possible to achieve focused enhancement of forward-propagating seismic waves, and more accurate imaging results of geological structures are obtained using reverse time migration imaging.

Advantages of additional aspects of this disclosure will be provided in part in the following description, and will become apparent in part from the following description, or may be learned through practice of this disclosure.

### BRIEF DESCRIPTION OF THE DRAWINGS

The accompanying drawings as a part of this disclosure are provided to further illustrate this disclosure. The examples of this disclosure and their descriptions are intended to explain this disclosure and do not constitute an undue limitation thereon.

FIG. 1 is a top view of an advanced detection apparatus for a tunnel boring machine based on seismic waves from a controllable seismic source according to Example 1 of this disclosure;

FIG. 2 is a side view of the advanced detection apparatus for a tunnel boring machine based on seismic waves from a controllable seismic source according to Example 1 of this disclosure;

FIG. 3 is a front view of the advanced detection apparatus for a tunnel boring machine based on seismic waves from a controllable seismic source according to Example 1 of this disclosure;

FIG. 4 is a schematic structural view of the advanced detection apparatus for a tunnel boring machine based on seismic waves from a controllable seismic source according to Example 1 of this disclosure;

FIG. 5 is a schematic view of a beamforming method according to Example 3 of this disclosure; and

FIG. 6 is a schematic view of obtaining a wave velocity of direct waves according to Example 3 of this disclosure;

where 1: three-component geophone; 2: working platform of the tunnel boring machine; 3: electromagnetic controllable seismic source assembly; 4: main control room; 5: telescopic push rod; 6: counterweight housing; 7: airbag; 8: support; 9: second base; 10: inflation device; 11: rock wall; 12: wavefront; 13: beam surface; and 14: first base.

### DETAILED DESCRIPTION

This disclosure will be further described with reference to the accompanying drawings and examples.

It should be noted that the following detailed description is exemplary and aims to further describe this disclosure. Unless otherwise specified, all technical and scientific terms used herein have the same meanings as those generally understood by a person of ordinary skill in the art to which this disclosure belongs.

The examples of this disclosure and the features in the examples can be combined with each other in case of no conflict.

### Example 1

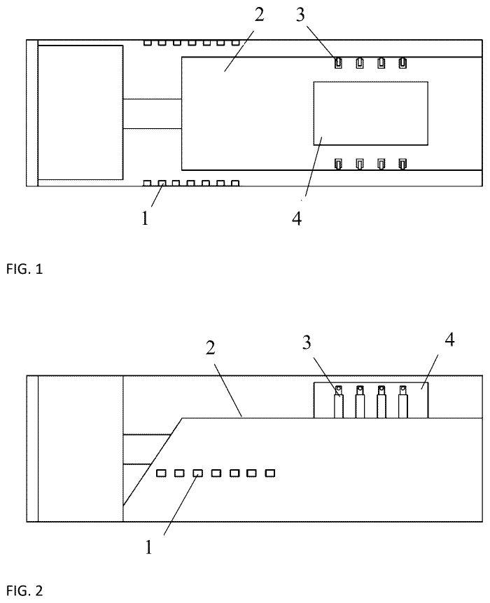

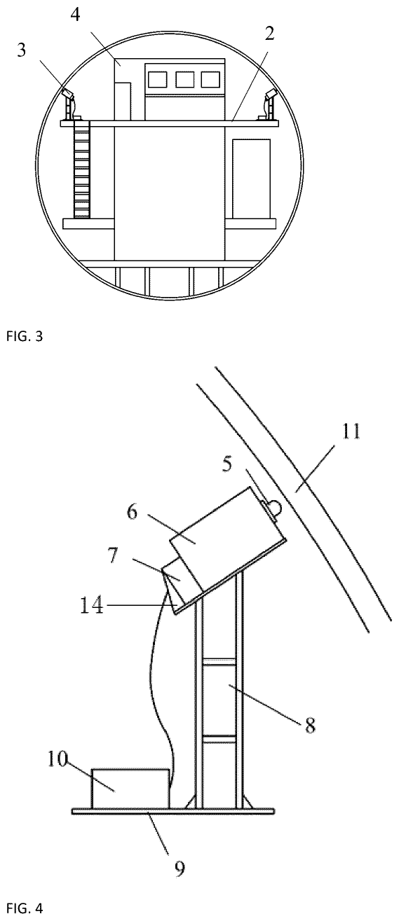

As shown in FIGS. 1, 2, 3, and 4, Example 1 of this disclosure provides an advanced detection apparatus for a tunnel boring machine based on seismic waves from a controllable seismic source, including: electromagnetic controllable seismic source assemblies 3 arranged on both sides of a working platform 2 of the boring machine (taking one assembly arranged on each side as an example);
the electromagnetic controllable seismic source assemblies 3 each include a telescopic push rod 5, a counterweight housing 6, an airbag 7, a support 8, a first base 14, and a second base 9, where the telescopic push rod 5 is fixed on a side of the counterweight housing 6 facing a rock wall 11; and
both the counterweight housing 6 and the airbag 7 are fixed to the first base 14, the airbag 7 is located on a side of the counterweight housing 6 distal from the telescopic push rod 5, the first base 14 is fixedly connected to the second base 9 via the support 8, and the second base 9 is configured to connect to the working platform 2 of the tunnel boring machine.

The telescopic push rod 5 in this example may be an electric telescopic rod, or a hydraulically or pneumatically controlled telescopic rod. Those skilled in the art can make a selection based on specific working conditions, which will not be elaborated herein.

In this example, the support 8 may be a hollow support frame (which can save costs) or a support plate (which provides higher stability). Those skilled in the art can make a selection based on specific working conditions, which will not be elaborated herein.

In this example, the apparatus further includes an inflation device 10 fixed on the second base 9, where the inflation device 10 is in communication with the airbag 7. In this example, an air pump is preferably used as the inflation device 10. It can be understood that, in some other implementations, inflation may also be achieved by discharging gas from a gas storage device, for example, using a gas cylinder. Those skilled in the art can make a selection based on specific working conditions, which will not be elaborated herein.

In this example, the apparatus further includes three-component geophones 1 arranged on the rock wall between a cutterhead and the electromagnetic controllable seismic source assemblies 3.

In this example, the three-component geophones 1 on both sides of a tunnel boring machine body are arranged symmetrically with respect to a central axis of the tunnel boring machine.

It can be understood that, in some other implementations, a plurality of electromagnetic controllable seismic source assemblies 3 are arranged on each side of the working platform 2 of the tunnel boring machine, and the electromagnetic controllable seismic source assemblies 3 on both sides are arranged symmetrically with respect to a central axis of the counterweight housing 6.

In this example, a main control room 4 is fixed on the working platform 2 of the tunnel boring machine, and the electromagnetic controllable seismic source assemblies 3 are located on both sides of the main control room 4.

### Example 2

Example 2 of this disclosure provides an operating method for the advanced detection apparatus for a tunnel boring machine based on seismic waves from a controllable seismic source described in Example 1, including the following steps:
S1: when detection starts, activating the electromagnetic controllable seismic source assemblies 3 on both sides of the working platform 2 of the tunnel boring machine, extending the telescopic push rods 5 of the electromagnetic controllable seismic source assemblies 3 and making them contact the rock wall 11, and simultaneously inflating the airbags 7 of the electromagnetic controllable seismic source assemblies 3 through the inflation device 10, so that front ends of the electromagnetic controllable seismic source assemblies 3 can be pressed firmly against the rock wall 11 and can provide a buffering effect when the electromagnetic controllable seismic source assemblies 3 are operating; and
S2: setting time-frequency information and output force information of the electromagnetic controllable seismic source assemblies 3 in the main control room 4, to achieve the purpose of known time-frequency information of seismic records and precise control of delayed emission of the plurality of electromagnetic controllable seismic source assemblies 3; and after the electromagnetic controllable seismic source assemblies 3 are activated, controlling, by moving coils inside the electromagnetic controllable seismic source assemblies 3, the counterweight housing 6 to vibrate, thereby exciting seismic signals.

### Example 3

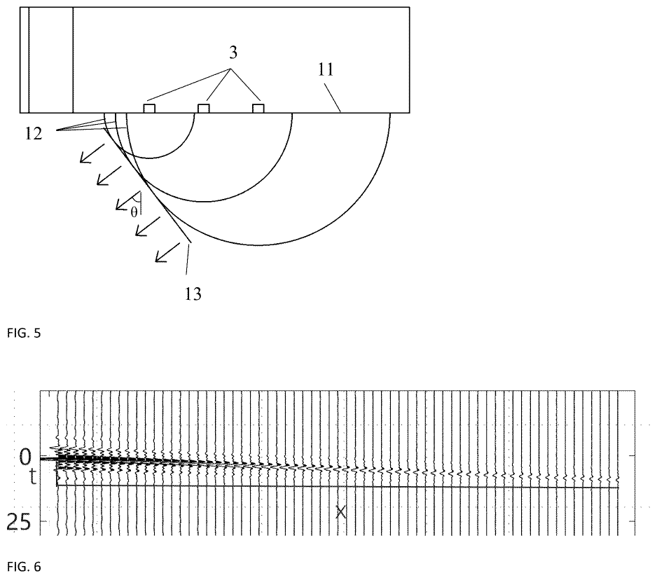

Since the space on both sides of the main control room 4 on the working platform 2 of the tunnel boring machine is relatively large in a tunnel axis direction, a sufficiently large number of electromagnetic controllable seismic source assemblies 3 can be installed and operated, enabling the implementation of a beamforming method. In view of this, this example provides an advanced detection method for a tunnel boring machine based on seismic waves from a controllable seismic source, as shown in FIG. 5, including the following steps:
S1: synthesizing, by means of delayed excitation of each electromagnetic controllable seismic source assembly 3, a wavefront 12 excited by each seismic source assembly in the form of spherical waves into a beam surface 13, and adjusting a propagation angle θ of the wavefront 12 through different delay lengths, where a propagation angle θ of the beam surface 13 is determined by the detection requirements, and when a forward propagation angle is θ, an excitation delay between each electromagnetic controllable seismic source assembly 3 is calculated as follows:

$$t = \frac{x sin θ}{v} ; \qquad ( 1 )$$

wherein, t represents a delayed excitation time of a current electromagnetic controllable seismic source assembly 3 relative to a previous electromagnetic controllable seismic source assembly 3; x represents a spacing between the electromagnetic controllable seismic source assemblies; v represents a wave velocity in surrounding rock; θ represents the propagation angle of the wavefront; a delayed excitation time of a first electromagnetic controllable seismic source assembly 3 t₀=0s; and a delayed excitation time of an nth electromagnetic controllable seismic source assembly

$$3 {t}_{n} = {\sum }_{i = 0}^{n} {t}_{i} ;$$

S2: receiving seismic records by three-component geophones 1 located in front of the electromagnetic controllable seismic source assemblies 3 (the three-component geophones 1 are located between the cutterhead and the electromagnetic controllable seismic source assemblies 3, and their specific positions may not be fixed, provided that they are arranged in groups along the tunnel axis direction), performing interferometric processing on seismic data from the controllable seismic source assemblies by means of cross-correlation, and obtaining a wave velocity of direct waves through analysis (the wave velocity of direct waves (v=x/t) is calculated from the slope of direct wave components in the seismic records, where v represents the wave velocity, x represents an arrangement length of the geophones, and t represents the delayed excitation time of the current electromagnetic controllable seismic source assembly 3 relative to the previous electromagnetic controllable seismic source assembly 3, as shown in FIG. 6);

$$R ( t ) = {\int }_{- ∞}^{+ ∞} f ( {t}_{0} - t ) g ( {t}_{0} ) {dt}_{0} ; \qquad ( 2 )$$

wherein, f(t₀) represents the seismic records; g(t₀) represents pilot geophone records; t₀ represents an integration variable for integration over all time; and R(t) represents interferometric seismic records generated by the cross-correlation.

In this example, a homogeneous initial velocity model is created based on a wave velocity result (when the wave velocity v of direct waves is obtained, this value is assigned to the formation by creating a matrix, where the “number of grids * set grid size” in the length, width, and height directions of the matrix is consistent with the actual formation, and the numerical values in the matrix represent the formation wave velocity, which is the wave velocity of direct waves);
S3: removing the direct waves in the interferometric seismic records; and
S4: exciting seismic records (autocorrelated wavelet records here) at a seismic source assembly position of the obtained initial velocity model to obtain a forward-propagating wavefield; applying the actually obtained interferometric seismic records with the direct waves removed in reverse time at positions of the geophones to obtain a reverse-propagating wavefield, and performing correlation stacking on the two wavefields to obtain a reverse time migration imaging result based on beamforming.

### Example 4

Example 4 of this disclosure provides a tunnel boring machine including the advanced detection apparatus for a tunnel boring machine based on seismic waves from a controllable seismic source according to Example 1 of this disclosure.

The foregoing is merely illustrative of the examples of this disclosure and is not intended to limit this disclosure. For those skilled in the art, this disclosure may have various modifications and changes. Any modifications, equivalent replacements, and improvements made within the spirit and principle of this disclosure shall fall within the scope of protection of this disclosure.

1. An advanced detection method for a tunnel boring machine based on seismic waves from a controllable seismic source, comprising the following steps:
synthesizing, by means of delayed excitation of each electromagnetic controllable seismic source assembly, a wavefront excited by each seismic source assembly in the form of spherical waves into a beam surface, and adjusting a propagation angle of the wavefront through different delay lengths;
when a forward propagation angle is θ, an excitation delay between each electromagnetic controllable seismic source assembly is calculated as follows:
$$t = \frac{x sin θ}{v} ;$$
wherein t represents a delayed excitation time of a current electromagnetic controllable seismic source assembly relative to a previous electromagnetic controllable seismic source assembly; x represents a spacing between the electromagnetic controllable seismic source assemblies; v represents a wave velocity in surrounding rock; θ represents the propagation angle of the wavefront; a delayed excitation time of a first electromagnetic controllable seismic source assembly t=0s; and a delayed excitation time of an n^{th} electromagnetic controllable seismic source assembly
$${t}_{n} = {\sum }_{i = 0}^{n} {t}_{i} ;$$
receiving seismic records by three-component geophones, performing interferometric processing on seismic data from the controllable seismic source assemblies by means of cross-correlation, obtaining a wave velocity of direct waves through analysis, and creating a homogeneous initial velocity model based on the wave velocity result;
removing the direct waves in interferometric seismic records;
exciting seismic records at a seismic source assembly position of the obtained initial velocity model to obtain a forward-propagating wavefield; applying the actually obtained interferometric seismic records with the direct waves removed in reverse time at positions of the three-component geophones to obtain a reverse-propagating wavefield; and
performing correlation stacking on the two wavefields to obtain a reverse time migration imaging result based on beamforming;
an advanced detection apparatus for a tunnel boring machine based on seismic waves from a controllable seismic source, comprising: the electromagnetic controllable seismic source assemblies arranged on both sides of a working platform of the tunnel boring machine and comprising a telescopic push rod, a counterweight housing, an airbag, a support, a first base, and a second base, wherein the telescopic push rod is fixed on a side of the counterweight housing facing a rock wall; and
both the counterweight housing and the airbag are fixed to the first base, the airbag is located on a side of the counterweight housing distal from the telescopic push rod, and the first base is fixedly connected to the second base via the support.

2. The advanced detection method for a tunnel boring machine based on seismic waves from a controllable seismic source according to claim 1, further comprising:
an inflation device fixed on the second base, wherein the inflation device is in communication with the airbag.

3. The advanced detection method for a tunnel boring machine based on seismic waves from a controllable seismic source according to claim 1, further comprising:
three-component geophones arranged on the rock wall between a cutterhead and the electromagnetic controllable seismic source assemblies.

4. The advanced detection method for a tunnel boring machine based on seismic waves from a controllable seismic source according to claim 3, wherein
the three-component geophones on both sides of a tunnel boring machine body are arranged symmetrically with respect to a central axis of the tunnel boring machine.

5. The advanced detection method for a tunnel boring machine based on seismic waves from a controllable seismic source according to claim 1, wherein
at least one electromagnetic controllable seismic source assembly is arranged on each side of the working platform of the tunnel boring machine, and the electromagnetic controllable seismic source assemblies on both sides are arranged symmetrically with respect to a central axis of the counterweight housing.

6. The advanced detection method for a tunnel boring machine based on seismic waves from a controllable seismic source according to claim 1, wherein
a main control room is fixed on the working platform of the tunnel boring machine, and the electromagnetic controllable seismic source assemblies are located on both sides of the main control room.

7. An operating method for the detection apparatus in the advanced detection method for a tunnel boring machine based on seismic waves from a controllable seismic source according to claim 1, comprising the following steps:
when detection starts, activating the electromagnetic controllable seismic source assemblies on both sides of the working platform of the tunnel boring machine, extending the telescopic push rods of the electromagnetic controllable seismic source assemblies and making them contact the rock wall, and simultaneously inflating the airbags of the electromagnetic controllable seismic source assemblies through the inflation device, so that the electromagnetic controllable seismic source assemblies can be pressed firmly against the rock wall; and
setting time-frequency information and output force information of the electromagnetic controllable seismic source assemblies, and after the electromagnetic controllable seismic source assemblies are activated, controlling, by moving coils inside the electromagnetic controllable seismic source assemblies, the counterweight housing to vibrate, thereby exciting seismic signals.

8. A tunnel boring machine, configured to:
implement the advanced detection method for a tunnel boring machine based on seismic waves from a controllable seismic source according to claim 1.
